(19) United States
(12) Patent Application Publication
(10) Pub. No.: US 2007/0156328 A1
(43) Pub. Date: Jul. 5, 2007

(54) Car navigation apparatus, PC card for information updating, and information updating method of car navigation apparatus

(75) Inventor: Minoru Nakamura, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 11/448,876

(22) Filed: Jun. 8, 2006

(30) Foreign Application Priority Data
Jan. 5, 2006 (JP) 2006-000547

(51) Int. Cl. G01C 21/00

(52) U.S. Cl. 701/200

(57) ABSTRACT

A car navigation apparatus includes: a mass storage device; an internal controller that reads out and processes information stored in the mass storage device; a PC card slot into which a PC card that communicates with an external device through the internal controller is inserted; a PC card controller that controls the PC card; a switch A installed on a storage device signal line connecting the mass storage device and the internal controller; a switch B installed on a PC card signal line connecting the PC card controller and the PC card slot; a bypass signal line that connects the storage device signal line and the PC card signal line; and a switch C installed on the bypass signal line. Opening and closing of the switches A, B, and C are controlled according to kind of the PC cardinserted in the PC card slot and whether the PC card is inserted in the PC card slot.

### BACKGROUND OF THE INVENTION

1. Field of the Invention

This invention relates to a car navigation apparatus comprising a mechanism capable of easily updating information stored in a mass storage device such as an incorporated hard disk device, a PC card for information updating used in the information updating, and an information updating method of the car navigation apparatus.

2. Description of the Related Art

A car navigation apparatus equipped with a mass storage device such as a hard disk device stores and holds and uses a large amount of information such as map information therein, and the information becomes obsolete with time, so that the information must be updated sequentially or as necessary.

In the case of a car navigation apparatus equipped with a CDROM drive or a DVD drive, information can be updated by reading updated information via these drives and updating information stored in a hard disk device. However, there are also many car navigation apparatus which are not equipped with the CDROM drive or the DVD drive at the request of compactification or economy. In such a case, in order to update information stored in a hard disk device, it was necessary for a user to bring a car equipped with a detachable car navigation apparatus into an information updating service provider such as a car dealer or its broker and detach the hard disk device and ask information updating. The car dealer etc. detach the hard disk device and the detached hard disk device is sent to a device maker. In the device maker sent, the information stored in the hard disk device is rewritten using a writing device for information updating prepared separately (see JP-A-2002-333323 (FIGS. 1 and 2), JP-A-2002-333324 (FIGS. 1 and 2) and JP-A-2004-53408 (Claim 1, FIG. 2)). After the rewriting, its hard disk device is again attached to the original car navigation apparatus via the car dealer.

Because it was necessary to detach the hard disk device and send the hard disk device to the device maker and again attach the hard disk device every rewriting thus, a period necessary for rewriting became long and a user could not use its car navigation apparatus during its period and also, cost of information updating was high.

Further, in the case of updating information through CDROM, a DVD, etc., it is necessary to equip the car navigation itself with a drive of the CDROM, the DVD, etc., so that, for example, an apparatus size becomes large and also many disks for updating are required, and there were problems of convenience of use, economy or compactification of an apparatus.

From such a background, means capable of easily updating information stored in a hard disk device without detaching the hard disk device has been desired.

### SUMMARY OF THE INVENTION

According to an aspect of the present invention, a car navigation apparatus includes: a mass storage device; an internal controller that reads out and processes information stored in the mass storage device; a PC card slot into which a PC card that communicates with an external device through the internal controller is inserted; a PC card controller that controls the PC card inserted into the PC card slot through the internal controller; a switch A installed on a storage device signal line that makes connection between the mass storage device and the internal controller; a switch B installed on a PC card signal line that makes connection between the PC card controller and the PC card slot; a bypass signal line that connects the storage device signal line between the switch A and the mass storage device to the PC card signal line between the switch B and the PC card slot; and a switch C installed on the bypass signal line. Opening and closing of the switch A, the switch B and the switch C are controlled according to a kind of the inserted PC card and a presence or absence of insertion of the PC card into the PC card slot.

According to another aspect of the present invention, a PC card for information updating used by being inserted into a PC card slot in case of direct writing of information on a mass storage device included in a car navigation apparatus, includes: a signal terminal structure and a shape capable of insertion into the PC card slot; and a storage device interface circuit that controls the direct writing of information through an external device on the mass storage device. The car navigation apparatus includes: an internal controller that reads out and processes information stored in the mass storage device; the PC card slot into which a PC card that communicates with an external device through the internal controller is inserted; a PC card controller that controls the PC card inserted into the PC card slot through the internal controller; a switch A installed on a storage device signal line that makes connection between the mass storage device and the internal controller; a switch B installed on a PC card signal line that makes connection between the PC card controller and the PC card slot; a bypass signal line that connects the storage device signal line between the switch A and the mass storage device to the PC card signal line between the switch B and the PC card slot; and a switch C installed on the bypass signal line, and opening and closing of the switch A, the switch B and the switch C are controlled according to a kind of the inserted PC card and the presence or absence of insertion of the PC card into the PC card slot.

According to yet another aspect of the present invention, an information updating method of a car navigation apparatus which includes: a mass storage device; an internal controller that reads out and processes information stored in the mass storage device; a PC card slot into which a PC card that communicates with an external device through the internal controller is inserted; a PC card controller that controls the PC card inserted into the PC card slot through the internal controller; a switch A installed on a storage device signal line that makes connection between the mass storage device and the internal controller; a switch B installed on a PC card signal line that makes connection between the PC card controller and the PC card slot; a bypass signal line that connects the storage device signal line between the switch A and the mass storage device to the PC card signal line between the switch B and the PC card slot; and a switch C installed on the bypass signal line, the method includes: directly rewriting information stored in the mass storage device through a PC card for information updating by controlling opening and closing of the switch A, the switch B and the switch C according to a presence or absence of insertion of the PC card for information updating into the PC card slot. The PC card for information updating is used by being inserted into the PC card slot in case of direct writing of information on the mass storage device, and includes: a signal terminal structure and a shape capable of insertion into the PC card slot; and a storage device interface circuit that controls the direct writing of information through an external device on the mass storage device.

By a car navigation apparatus, a PC card for information updating and an information updating method according to the invention, information stored in a mass storage device of the inside of the car navigation apparatus can easily be rewritten without detaching a hard disk device mounted, and use downtime of the car navigation apparatus associated with rewriting work can be reduced significantly than ever before and also, cost necessary for the rewriting can be reduced.

### BRIEF DESCRIPTION OF THE DRAWINGS

FIG. 1 is a diagram showing a configuration of a car navigation apparatus according to the invention of the present application.

### DETAILED DESCRIPTION OF THE INVENTION

### First Embodiment

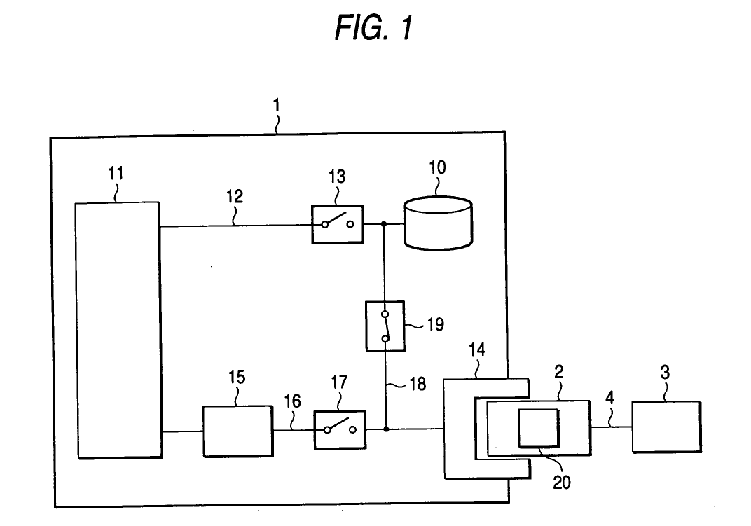

FIG. 1 is a diagram showing a configuration of a car navigation apparatus according to a first embodiment for carrying out the invention.

In FIG. 1, numeral 1 is a car navigation apparatus, and numeral 10 is a hard disk device with which the car navigation apparatus 1 is equipped, and numeral 11 is an internal controller for performing various processing and control of the car navigation apparatus 1 and is often called a microcontroller normally. Numeral 12 is a hard disk signal line for making connection between the hard disk device 10 and the internal controller 11 and normally, an ATA (AT Attachment; ANSI NCITS 340-2000, INFORMATION TECHNOLOGY-AT ATTACHMENT WITH PACKET INTERFACE-5 (ATA/ATAPI-5)) bus is often used. Numeral 13 is a switch A which is installed on this hard disk signal line 12 and opens and closes the signal line 12, and numeral 14 is a PC card slot into which a general-purpose PC card can be inserted, and numeral 2 is a PC card for information updating used at the time of rewriting information stored in the hard disk device 10 and is made so as to be able to be inserted into the PC card slot 14. Numeral 15 is a PC card controller for accessing the general-purpose PC card inserted into the PC card slot 14 by instructions of the internal controller 11, and numeral 16 is a PC card signal line for making connection between the PC card controller 15 and the PC card slot 14, and numeral 17 is a switch B which is installed on the PC card signal line 16 and opens and closes the PC card signal line 16, and numeral 18 is a bypass signal line for connecting the hard disk signal line 12 between the hard disk device 10 and the switch A13 and connecting the PC card signal line 16 between the PC card slot 14 and the switch B17, respectively, and numeral 19 is a switch C which is installed on the bypass signal line 18 and opens and closes the bypass signal line 18, and numeral 3 is an external controller connected to the PC card 2 for information updating inserted into the PC card slot 14 and a personal computer can also be used. Numeral 4 is an external signal line for making connection between the external controller 3 and the PC card 2 for information updating, and numeral 20 is a hard disk interface circuit which controls information writing on the hard disk device and is incorporated into the PC card 2 for information updating. The switches A13, B17, C19 become bus switches when a bus is used as each of the signal lines. In addition, the configuration of the car navigation apparatus 1 shown in FIG. 1 shows only components directly related to the invention of the present application and does not exclude the inclusion of other components.

The difference between a conventional car navigation apparatus and the car navigation apparatus 1 according to the invention of the present application in the configuration is that the switch A13, the switch B17, the bypass signal line 18 and the switch C19 are present. In the conventional car navigation apparatus, these switches and the bypass signal line 18 were not present.

Next, an action of the car navigation apparatus 1 according to the invention of the present application will be described.

The car navigation apparatus 1 according to the invention of the present application can be used in at least two modes of an information updating mode and a normal use mode. The information updating mode means a use state of rewriting information stored in a hard disk device, and the normal use mode means all the use states other than the information updating mode and corresponds to a use state of the conventional car navigation apparatus.

In the normal use mode, the switch A13 and the switch B17 of this car navigation apparatus 1 are in a closed state and the switch C19 is in an opened state. The states are the same as those of a configuration of the conventional car navigation apparatus, and the internal controller 11 can access the hard disk device 10 and the PC card slot 14 in a standard manner. That is, the car navigation apparatus 1 can communicate with the outside by inserting a general-purpose PC card into the PC card slot 14. The internal controller 11 controls the PC card controller 15 and thereby, this communication is conducted through the PC card signal line 16 and the general-purpose PC card inserted into the PC card slot 14. Also, the internal controller 11 reads information out of the hard disk device 10 through the hard disk signal line 12. The connection between the PC card slot 14 and the hard disk device 10 is not made.

In the information updating mode, the switch A13 and the switch B17 of this car navigation apparatus 1 are in an opened state and the switch C19 is in a closed state, and the hard disk device 10 and the PC card slot 14 are separated from control by the internal controller 11. Then, the switch C19 is in the closed state, so that the hard disk device 10 is directly connected to the PC card slot 14 through the bypass signal line 18.

In the case of information updating, the PC card 2 for information updating is inserted into the PC card slot 14 and the external controller 3 for controlling information updating is connected to the PC card 2 for information updating through the external signal line 4. Since the hard disk interface circuit 20 is incorporated into the PC card 2 for information updating, the external controller 3 can rewrite information stored in the hard disk device 10 directly through the PC card 2 for information updating.

Here, as long as the hard disk device 10 is a drive device (a mass storage device) of a mass storage medium connected by an ATA interface, any hard disk device can be substituted. For example, a mass silicon disk into which flash memory is integrated can also be used.

Next, the PC card 2 for information updating will be described.

The PC card 2 for information updating has a commonality with the general-purpose PC card in use by being inserted into the PC card slot 14. The difference is that the PC card 2 for information updating incorporates the hard disk interface circuit 20 and has a function of directly updating information stored in the hard disk device 10.

In the information updating mode, the switch B17 becomes the opened state and the PC card slot 14 is separated from the PC card controller 15, so that a signal different from a signal of the PC card signal line 16 allocated in the normal use mode can be allocated to the PC card 2 for information updating.

Since a much similar signal is used in the signal of the PC card signal line 16 and an ATA signal used by the hard disk device 10, it is easy to allocate the ATA signal to a signal of the PC card for information updating. Actually, in PC card specifications, a signal definition for making a PC card compatible with a hard disk device is given as a TRUE ATA mode. In the PC card for information updating, the hard disk device 10 is accessed from the PC card side, so that polarity of a signal is opposite but this TRUE ATA mode can be applied as arrangement of a signal.

In addition, by providing the PC card 2 for information updating with a function of conversion from an ATA signal into a general-purpose interface signal such as a USB signal in addition to the hard disk interface circuit 20, a personal computer generally becoming widespread can be used as the external controller 3. For that purpose, a bus conversion circuit constructed of an ATA-USB2.0 bridge IC or an ATA-IEEE1394 bridge IC, etc. is incorporated into the PC card 2 for information updating. As a result of this, the PC card 2 for information updating can be connected to the external controller 3 using a general-purpose interface such as a USB and a personal computer can be used as the external controller 3. By being constructed thus, the need for a special device is eliminated in information updating of the hard disk device 10 of this car navigation apparatus 1.

The bus conversion circuit can also be mounted in the inside of the car navigation apparatus 1 rather than the inside of the PC card 2 for information updating. In this case, a USB signal can be directly inputted and outputted from the PC card via the PC card slot 14, but when a USB connector is previously prepared for information updating in the car navigation apparatus 1, the handling can be performed without using the PC card.

However, there is the following problem when the bus conversion circuit is incorporated into a car-mounted device such as a car navigation apparatus and is used.
(1) In parts used in the car-mounted device, because of, for example, large vibration or temperature variation range under installation environment, high reliability on these factors is desired. The ATA-USB2.0 bridge IC etc. are mainly used as a consumer-oriented IC and it is difficult to acquire an IC with high reliability capable of being used in a car-mounted state.

In the consumer-oriented IC, a model change cycle is short and supply is not stable.

As a result of this, the bus conversion circuit is incorporated into the PC card 2 for information updating and is used. In the case of being incorporated into the PC card 2 for information updating, high reliability on temperature or vibration environment is not desired, so that selection of an electronic device is facilitated. Also, as described below, a rewriting provider of information inside a hard disk device, for example, a car dealer is assumed as a holder of the PC card 2 for information updating, so that stability of supply does not become a large problem. Further, cost is lower as compared with equipping all the car navigation apparatus with the bridge IC described above.

Also, there is a choice of incorporating these interface circuits into the external controller 3 without incorporating the interface circuits into the PC card 2 for information updating. However, in this case, a problem that a general-purpose personal computer cannot be used as the external controller arises. In a method of using the PC card 2 for information updating, such a problem is avoided.

As described above, the PC card 2 for information updating according to the invention of the present application does not conform to standards of a general-purpose PC card and is not called a PC card strictly, so that the PC card 2 is called a PC card for “information updating”. The reason why the PC card 2 does not conform to the standards is because the PC card 2 for information updating is controlled by the external controller 3 at the time of information updating and it is not assumed that the PC card 2 is controlled by the internal controller 11 through the PC card controller 15.

As described already, a personal computer can be used as the external controller 3. When the personal computer is used as the external controller 3, a speedup in information updating can be achieved by using a high-speed interface such as USB or IEEE394 in connection to the PC card 2 for information updating. It is highly effective in reduction in rewriting time of information stored in the hard disk device 10 in conjunction with direct rewriting of the information stored in the hard disk device 10 by the PC card 2 for information updating.

Next, control of opening and closing of the switches A13, B17, C19 will be described. As described above, switching from the normal use mode to the information updating mode includes switching of opening and closing of the switches A13, B17, C19 and with respect to this switching method, some concrete examples are shown below.

(1) First Method

When the car navigation apparatus 1 has a function of switching for mode selection, a user makes a selection manually and thereby, a selection signal is generated and switching between a normal use mode and an information updating mode is performed. A selection may be made by a switching switch or a method for inputting a command to instruct a selection by input means such as a keyboard may be used. By inputting this selection signal to the internal controller 11, switching to the information updating mode is recognized and an opening and closing control signal is outputted from the internal controller 11 to each of the switches. Also, each of the switches may be opened and closed directly by the selection signal without the intervention of the internal controller 11. In order to return the mode to the normal use mode, an operation similar to that at the time of the selection described above could be performed.

(2) Second Method

The PC card 2 for information updating is inserted into the PC card slot 14 and a recognition signal is outputted using an unused signal of a general-purpose PC card and this recognition signal is used as the selection signal in the first method and thereby, opening and closing of each of the switches are controlled by the method described by the first method. In this case, signal lines different from the illustrated signal lines 12, 16, 18 shall be used as input and output of the recognition signal to the internal controller 11. These signal lines are generally lines having plural signal lines such as buses, and FIG. 1 shows a part of the signal lines, and other signal lines can be used.

According to this method, control can be performed automatically so that the switch A13 and the switch B17 are in an opened state and the switch C19 is in a closed state by only inserting the PC card 2 for information updating into the PC card slot 14. In order to return the mode to the normal use mode, the PC card 2 for information updating could be withdrawn from the PC card slot 14.

(3) Third Method

With respect to opening and closing of the switch B17, a function of the PC card controller 15 may be used. The PC card controller 15 generally incorporates a circuit for disconnecting a signal on the PC card signal line 16 when a PC card is not connected, and using this function, the switch B17 can be omitted. In this function, generally, the internal controller 11 recognizes a card detection signal outputted from a general-purpose PC card and the internal controller 11 connects the signal on the PC card signal line 16 through the PC card controller 15, so that when the PC card 2 for information updating is inserted into the PC card slot 14, it is constructed so that the PC card 2 for information updating does not output the card detection signal so as not to actuate this function, that is, in order to maintain a state in which the signal on the PC card signal line 16 is disconnected.

The PC card for information updating has the same shape as that of a normal PC card, but a different signal is used, so that when the PC card for information updating is accidentally inserted into another apparatus such as a personal computer having a PC card slot, there is a possibility of causing a failure or a malfunction in the apparatus. By constructing the PC card for information updating so as not to output the card detection signal as described above, even when the PC card 2 for information updating is accidentally inserted into another apparatus such as a personal computer having a PC card slot, its apparatus is not recognized as the PC card, so that a failure or a malfunction can be prevented.

In this case, insertion of the PC card 2 for information updating cannot be detected also in a device compatible with the PC card for information updating, so that using an unused signal of the PC card, the internal controller 11 is notified of insertion of the PC card 2 for information updating. In addition, an input to the internal controller 11 of a signal from the unused signal is executed through a signal line in which the description is omitted in FIG. 1. That is, the PC card signal line 16 is normally constructed of plural signal lines, so that by constructing a part of the signal lines without the intervention of the switch B17, the input can easily be done through this signal line.

By disposing the switches A13, B17, C19 and the bypass signal line 18 and properly controlling opening and closing of the switches A13, B17, C19 thus, storage information can be rewritten by directly accessing the hard disk device 10 from the outside through the PC card 2 for information updating which is inserted into the PC card slot 14 and incorporates the hard disk interface circuit 20. Also, in that case, a change in built-in software of the car navigation apparatus 1 can be minimized by separating rewriting of information stored in the hard disk device 10 from control of the internal controller 11. Further, by providing the PC card for information updating with a function of conversion from an ATA signal into a USB signal, updating of the hard disk device incorporated into the car navigation apparatus 1 can be performed from a personal computer generally becoming widespread. Also, in this car navigation apparatus 1, by preparing the PC card for information updating, a situation in which information on the hard disk device is accidentally rewritten can be prevented.

The car navigation apparatus 1 according to the invention of the present application has the function as described above and thereby, when a user brings a car into a rewriting service provider, for example, a car dealer at the time of rewriting, it becomes unnecessary to detach the hard disk device 10 from the car navigation apparatus 1 (detach the whole car navigation apparatus 1 from the car in some cases) and send this hard disk device to a device maker conventionally, and when the rewriting service provider holds the PC card 2 for information updating and the external controller 3 such as a personal computer, information stored in the hard disk device 10 can be rewritten and updated on the spot with the hard disk device 10 attached to the car navigation apparatus 1 using the PC card 2 and the external controller 3. Therefore, updating processing can be ended in a short time, and a period during which the car navigation apparatus cannot be used can also be reduced accordingly.

In addition, even when the hard disk device 10 is other kinds of mass storage device, the hard disk device 10 can have an effect similar to that described above.

1. A car navigation apparatus comprising:
a mass storage device;
an internal controller that reads out and processes information stored in the mass storage device;
a PC card slot into which a PC card that communicates with an external device through the internal controller may be inserted;
a PC card controller that controls a PC card inserted into the PC card slot through the internal controller;
a switch A installed on a storage device signal line that connects the mass storage device and the internal controller;
a switch B installed on a PC card signal line that connects the PC card controller and the PC card slot;
a bypass signal line that connects the storage device signal line between the switch A and the mass storage device to the PC card signal line between the switch B and the PC card slot; and
a switch C installed on the bypass signal line, wherein opening and closing of the switch A, the switch B, and the switch C are controlled according to kind of the PC card that is inserted in the PC card slot and whether the PC card is inserted in the PC card slot.

2. The car navigation apparatus as claimed in claim 1, wherein
the switch A and the switch B are opened and the switch C is closed by making a connection by inserting a PC card for information updating into the PC card slot, and
the PC card for information updating is used by being inserted into the PC card slot in case of direct writing of information on the mass storage device, and includes:
a signal terminal structure and a shape capable of insertion into the PC card slot, and
a storage device interface circuit that controls the direct writing of information through an external device on the mass storage device.

3. The car navigation apparatus as claimed in claim 1, wherein
control of the mass storage device is separated from the internal controller by making a connection by inserting a PC card for information updating into the PC card slot, and
the PC card for information updating is used by being inserted into the PC card slot in case of direct writing of information on the mass storage device, and includes:
a signal terminal structure and a shape capable of insertion into the PC card slot, and
a storage device interface circuit that controls the direct writing of information through an external device on the mass storage device.

4. The car navigation apparatus as claimed in claim 1, wherein
the switch B is substituted by giving the PC card controller an instruction to disconnect a signal on the PC card signal line by making a connection by inserting a PC card for information updating into the PC card slot, and
the PC card for information updating is used by being inserted into the PC card slot in case of direct writing of information on the mass storage device, and includes:
a signal terminal structure and a shape capable of insertion into the PC card slot, and
a storage device interface circuit that controls the direct writing of information through an external device on the mass storage device.

5. A PC card for information updating used by being inserted into a PC card slot in case of direct writing of information on a mass storage device included in a car navigation apparatus, comprising:
a signal terminal structure and a shape capable of insertion into the PC card slot; and
a storage device interface circuit that controls the direct writing of information through an external device on the mass storage device, wherein the car navigation apparatus includes:
an internal controller that reads out and processes information stored in the mass storage device,
the PC card slot into which a PC card that communicates with an external device through the internal controller may be inserted,
a PC card controller that controls a PC card inserted into the PC card slot through the internal controller,
a switch A installed on a storage device signal line that connects the mass storage device and the internal controller,
a switch B installed on a PC card signal line that connects the PC card controller and the PC card slot,
a bypass signal line that connects the storage device signal line between the switch A and the mass storage device to the PC card signal line between the switch B and the PC card slot; and
a switch C installed on the bypass signal line, and
opening and closing of the switch A, the switch B, and the switch C are controlled according to kind of PC card that is inserted in the PC card slot and whether the PC card is inserted in the PC card slot.

6. The PC card for information updating as claimed in claim 5, further comprising a bus conversion circuit.

7. The PC card for information updating as claimed in claim 5, further comprising a unit that issues a signal to recognize whether PC card is for direct writing on a mass storage device upon insertion into the PC card slot.

8. An information updating method of a car navigation apparatus which comprises:
a mass storage device;
an internal controller that reads out and processes information stored in the mass storage device;
a PC card slot into which a PC card that communicates with an external device through the internal controller may be inserted;
a PC card controller that controls a PC card inserted in the PC card slot through the internal controller;
a switch A installed on a storage device signal line that connects the mass storage device and the internal controller;
a switch B installed on a PC card signal line that connects the PC card controller and the PC card slot;
a bypass signal line that connects the storage device signal line between the switch A and the mass storage device to the PC card signal line between the switch B and the PC card slot; and
a switch C installed on the bypass signal line, the method comprising:
directly rewriting information stored in the mass storage device through a PC card for information updating by controlling opening and closing of the switch A, the switch B, and the switch C according to whether the PC card for information updating is inserted in the PC card slot, wherein
the PC card for information updating is used by being inserted into the PC card slot in case of direct writing of information on the mass storage device, and includes:
a signal terminal structure and a shape capable of insertion into the PC card slot, and
a storage device interface circuit that controls the direct writing of information through an external device on the mass storage device.

9. The information updating method of a car navigation apparatus as claimed in claim 8, wherein the switch B is substituted by giving a PC card controller an instruction to disconnect a signal on the PC card signal line by making a connection by inserting the PC card for information updating into the PC card slot.
